(19) United States
(12) Patent Application Publication
(10) Pub. No.: US 2026/0268696 A1
(43) Pub. Date: Sep. 10, 2026

(54) OBJECT SEPARATION IN IMAGE DATA

(71) Applicant: Commonwealth Scientific and Industrial Research Organisation, Acton (AU)

(72) Inventors: Chuong Nguyen, Acton (AU); Jinguang Tong, Acton (AU)

(73) Assignee: Commonwealth Scientific and Industrial Research Organisation, Acton (AU)

(21) Appl. No.: 19/555,492

(22) Filed: Mar. 3, 2026

(30) Foreign Application Priority Data
Mar. 6, 2025 (AU) 2025900673

(51) Int. Cl. G06V 20/64; G06T 7/73; G06T 15/20

(52) U.S. Cl. CPC G06V 20/647; G06T 7/75; G06T 15/205; G06T 2207/30204

(57) ABSTRACT

This disclosure relates to a method for separating an object in image data comprising multiple images of the object in a scene, the object being subject to a movement relative to the scene over the multiple images. The method comprises creating a three-dimensional point-based model of the scene, the three-dimensional point-based model comprising multiple parameterised point elements configured to provide an approximation of the scene in three dimensions from the multiple images, the three-dimensional point-based model comprising model parameters including an indicator parameter for each point element indicative of whether that point element belongs to the object in the scene. The method further comprises optimising the model parameters of the point elements to enhance the approximation of the scene by the model, including optimising the indicator parameter for each point element to segment the object in the scene.

### RELATED APPLICATIONS

This is a U.S. utility application which claims priority to Australian application number 2025900673, filed Mar. 6, 2025, pursuant to 35 U.S.C. § 119 (a), the entire contents of which are incorporated herein by reference.

### TECHNICAL FIELD

This disclosure relates to separation of an object in image data comprising multiple images.

### BACKGROUND

Object separation relates to separating a foreground object from a background, which may be useful for downstream applications such as object recognition, tracking, and scene understanding. By identifying and isolating relevant objects from the background, object separation facilitates accurate measurements and enhances the performance of subsequent image analysis tasks.

It is noted that in some applications it is possible to control the background and in those cases, chroma keying, such as using a green screen or blue screen, can be used to separate the object. However, in other uncontrollable environment, such a solution is not available. This can be, for example, in real-world scenarios or where the additional screen would interfere with the equipment. For example, in the case of using multiple cameras, the screen would obstruct the view of the cameras or in the case of using a robot arm for the camera, the screen would block movement of the robot arm.

Object separation can also be used in three-dimensional object reconstruction. In that process, multiple images of the object are captured from different directions and the aim is to create a three-dimensional description of the object. The process of three-dimensional object reconstructions works significantly better when the object is separated from the background so that only the object is reconstructed and the background can be ignored.

Some object separation and object reconstruction methods provide good performance under the assumption that both object and background are static (i.e. they do not move). However, a particularly challenging situation arises in cases where the object moves relative to the background. In that scenario, the separation is challenging and may be different in each of the multiple images of the object.

Therefore, there is a need for an improved method that provides better results in cases where the object moves relative to the background over multiple images.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

This disclosure provides a method for object separation where the scene in multiple images is modelled in three-dimensional space by a point-based model. The disclosed method does not require an object mask, which is an advantage over other methods. Each point of the point based model has a parameter that indicates whether that point belongs to the object or the background (or other objects). By optimising the parameters of the point-based model, including the parameter that indicates object/background, the image is segmented since, by the end of the optimisation process, the optimised parameter values indicate for each pixel whether that pixel belongs to the object or the background.

Provided herein is a method for separating an object in image data comprising multiple images of the object in a scene, the object being subject to a movement relative to the scene over the multiple images. The method comprises:
creating a three-dimensional point-based model of the scene, the three-dimensional point-based model comprising multiple parameterised point elements configured to provide an approximation of the scene in three dimensions from the multiple images, the three-dimensional point-based model comprising model parameters including an indicator parameter for each point element indicative of whether that point element belongs to the object in the scene; and
optimising the model parameters of the point elements to enhance the approximation of the scene by the model, including optimising the indicator parameter for each point element to segment the object in the scene.

It is an advantage that the indicator parameter is optimised for each point because this leads to an accurate separation of the object from other content of the scene in the images, such as the background. It is a further advantage that the point-based model comprising the point elements can be trained with high computational efficiency requiring less time than neural radiant fields, for example.

In some embodiments, the method further comprises, selectively applying a spatial transformation to each of the point elements depending on the indicator parameter, the spatial transformation being specific for each of the multiple images to account for a pose of the object in that image according to the movement.

It is an advantage that the spatial transformation relates to a pose of the object because this enables the robust separation of objects that move, such as rotate, relative to the background of the scene.

In some embodiments, selectively applying a spatial transformation comprises multiplying the indicator parameter with the transformation to calculate a weighted sum of transformed point elements.

In some embodiments, the spatial transformation is related to a rotation of the object in the scene.

In some embodiments, optimising the parameters comprises, for each image, reducing an error between (i) that image and (ii) a rendered representation of the model with the applied spatial transformation specific for that image to account for the pose of the object in that image according to the movement.

In some embodiments, the method further comprises determining the spatial transformation based on the image data by one or more of (i) detecting a fiducial marker in the image data and determining a pose of the object based on the fiducial marker or (ii) receiving movement data from a sensor configured to detect the movement of the object.

In some embodiments, the indicator parameter is indicative of whether that point element belongs to the object in the scene or to the background behind the object.

In some embodiments, the indicator parameter is continuous between (i) a first value indicating that the point element belongs to the object and (ii) a second value indicating that the point element belongs to a background.

In some embodiments, the indicator parameter is continuous and optimising the parameters comprises performing a gradient descent method.

In some embodiments, the scene comprises multiple moving objects and one or more indicator parameters for each point element are indicative of whether that point element belongs to one of the multiple objects in the scene.

In some embodiments, each of the point elements comprises a Gaussian radiance field configured by a set of spatial parameters that are optimised to enhance the approximation of the scene by the model.

In some embodiments, the Gaussian radiance field is two-dimensional to approximate surfaces in the scene.

In some embodiments, the method further comprises
defining the point elements in a local coordinate system;
generating a rendered representation of the model by spatially transforming each point element from the local coordinate system to a global coordinate system; and
optimising the parameters by reducing an error between the rendered representation and a corresponding one of the multiple images.

In some embodiments, spatially transforming each point element from the local coordinate system to the global coordinate system is based on the indicator parameter for that point element to apply a spatial transform associated with the object to point elements that belong to the object according to the indicator parameter.

In some embodiments, the method further comprises creating a three-dimensional representation of the object consisting of the point elements for which the indicator parameter indicates that the point elements belong to the object.

In some embodiments, optimising the parameters is performed under a local consistency constraint that encourages that near point elements have a similar indicator parameter.

In some embodiments, optimising the parameters is performed using a point-wise loss function that encourages the indicator parameter to become deterministic.

In some embodiments, the method further comprises generating an output image in which the indicator parameter is used as a colour value for each point element.

In some embodiments, the method further comprises applying a two-dimensional segmentation regularization on the output image.

There is further provided a computer system for separating an object in image data comprising multiple images of the object in a scene, the object being subject to a movement relative to the scene over the multiple images. The computer system comprises one or more processors configured to:
create a three-dimensional point-based model of the scene, the three-dimensional point-based model comprising multiple parameterised point elements configured to provide an approximation of the scene in three dimensions from the multiple images, the three-dimensional point-based model comprising model parameters including an indicator parameter for each point element indicative of whether that point element belongs to the object in the scene; and
optimise the model parameters of the point elements to enhance the approximation of the scene by the model, including optimising the indicator parameter for each point element to segment the object in the scene.

### BRIEF DESCRIPTION OF DRAWINGS

FIG. 1 illustrates an example scene.

FIG. 2 illustrates a method for segmentation of an object.

FIG. 3 provides an illustrative example of a point-based model.

FIG. 4 illustrates a binary mask that represents the segmentation of the object from the background.

FIG. 5 illustrates more detail of the method of FIG. 2. Portions of FIG. 5 are in color.

FIG. 6 illustrates how cluttered and static background poses a serious challenge for 3D reconstruction of moving objects, for example when using a rotating table for scanning. All existing methods here fail to reconstruct the object without input masks for background removal. They perform much better with input masks, but still perform worse than the disclosed method without input masks. Portions of FIG. 6 are in color.

FIG. 7 illustrates qualitative reconstruction results comparison on the real dataset. Portions of FIG. 7 are in color.

FIG. 8 illustrates a computer system to perform the method disclosed herein.

FIG. 9 illustrates a comparison between forward shading and deferred shading. Portions of FIG. 9 are in color.

FIG. 10 illustrates a rotated volume containing the object rotate and an intersected segment of the tracing ray around the z-axis as colour information is projected. Portions of FIG. 10 are in color.

FIG. 11 illustrates a variation of colour intensity is accounted for as a function of the distance to light source and incident angles θ_{d} and θₗ to surface normal.

### DESCRIPTION OF EMBODIMENTS

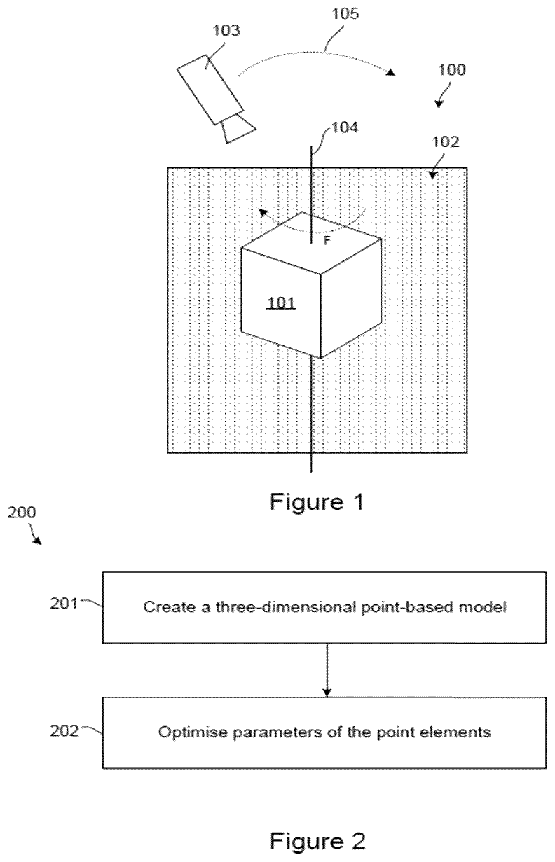

FIG. 1 illustrates an example scene 100 comprising an object 101 in front of a background 102. A camera 103 captures multiple images of scene 100. The object 101 is subject to a movement relative to the scene 100 over the multiple images. That is, the object 101 moves relative to the scene 100 and relative to background 102. The movement may comprise a rotation or a translation. In the example of FIG. 1, the movement is a rotation about a rotation axis 104 indicated by a letter ‘F’ for “foreground”, which is also the letter used to represent the three-dimensional spatial transformation of the object relative to the world coordinate system. The world coordinate system comprises an arbitrary point of origin (the point of xyz coordinates 0,0,0) with three arbitrary independent basis vectors. It is convenient but not necessary to choose orthogonal unit basis vectors and to place the point of origin at the centre of object 101 and on rotation axis 104 and place one of the basis vectors colinear with rotation axis 104. This way, there are more zero-elements in the corresponding transformation matrix, which makes computations more efficient. However, the proposed method is equally applicable to other choices of the world coordinate system.

Similar to object 101, camera 103 may also be subject to camera movement as indicated by arrow 105 in FIG. 1. In this example, camera movement is also a rotation about a point on axis 104. However, camera movement may also comprise other rotations and translations. As the object 101 and camera 103 move the camera 103 captures multiple images of the object 101. Those images capture the object from different directions and therefore provide spatial information over multiple images. The aim is to build a three-dimensional model of the object from this image information and to separate the object 101 from the background 102 in the images. Since the disclosed process results in the separation of segments of the images that belong to the object from segments that belong to the background, the process of object separation is also referred to as image segmentation herein. It is noted, however, that image segmentation in this sense does not necessarily include the classification of segments. Further, the disclosed process is not applied to a single image but to multiple images that also serve to reconstruct the object into a three dimensional model. So the term image segmentation used herein refers to separating a foreground object from the background over multiple images to then build a three-dimensional point-based model of the object. The process of object separation may also be referred to as image matting.

FIG. 2 illustrates a method 200 for separation of object 101 in image data comprising multiple images of the object 101 in a scene 100. As set out above, the object 101 is subject to a movement relative to the scene 100 over the multiple images. As pointed out before, method 200 does not require a mask for the object. Instead, method 200 comprises creating 201 a three-dimensional point-based model of the scene 100. The three-dimensional point-based model comprises multiple parameterised point elements configured to provide an approximation of the scene in three dimensions from the multiple images.

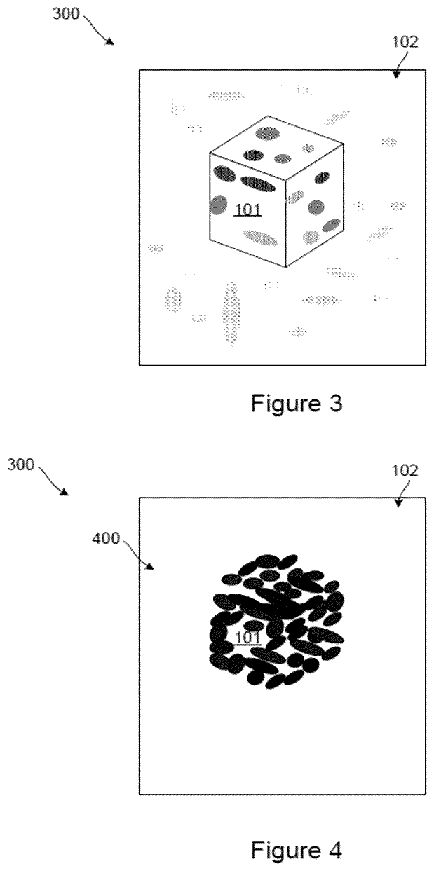

FIG. 3 provides an illustrative example of a point-based model 300. “Point-based” in this context means that the model comprises multiple points that relate to points in the images. That is, the points cover the image of the entire scene, which means the points cover the object as well as the background. The points are in the three-dimensional space of the model, which may be different from the world coordinate system. This means that each point of the point based model has an associated location within the three-dimensional space. In that sense, the point-based model may also be seen as a sampling of the three-dimensional scene. At each of the points, the model has a point element that is parameterised by the parameters of that point element. The parameters of each point may include the three-dimensional coordinates, such as cartesian, orthogonal coordinates x,y,z or polar coordinates like latitude, longitude, elevation, or other coordinates. In FIG. 3, each point element is represented by an ellipse and the location of each point is determined by the coordinates of the corresponding centre in three dimensions. The ellipses are used for illustrative purposes noting that they represent Gaussian distributions as described below.

The parameters of each point element may further comprise size parameters, such as the length of the two axes of the ellipse and three rotation parameters to represent the rotation of that ellipse about the three coordinate axes respectively. It can be seen in FIG. 3, that the ellipses (i.e. point elements) have different sizes/dimensions and are rotated.

The method 200 further comprises optimising 202 the parameters of the point elements to enhance the approximation of the scene by the model. That is, the method comprises adjusting the parameters of each ellipse/Gaussian, i.e. the parameters of each point element, iteratively so that the point elements approximate the scene optimally. This involves generating an image from the model 300 and comparing that rendered image to the image captured by camera 103. In this rendering step, each point element may contribute to the pixel values of the rendered image according to a Gaussian distribution parameterised by the parameters of the point element with the coordinates of the ellipse being the maximum of the Gaussian distribution. The optimisation process calculates the error between the rendered image and the captured images and uses backpropagation and/or gradient descent methods to optimise the parameters of the point elements to minimise the error. The point elements may also comprise a transparency parameter that can be optimised.

Further, the parameters of the point elements comprise an indicator parameter for each point element indicative of whether that point element belongs to the object in the scene and optimising the parameters of the point elements comprises optimising also the indicator parameter for each point element. In effect, this segments the object in the scene because it assigns a high indicator parameter value to object points and a low indicator parameter value to background points. In FIG. 3, the value of the indicator parameter for each point element (ellipse) is illustrated by different shading. Dark shading indicates that point elements belong to the object while light shading indicates that point elements belong to the background. At the end of the optimisation process, in an ideal case, there would be only black point elements for the object and white point elements for the background. In practice this may not be achievable but can be enforced by a post-processing step as set out below. Accordingly, “segmentation” in this context means that for each pixel or point in the image, the method determines whether that point shows the object or the background. This may be referred to as a binary mask. It is noted that this indication may be calculated for each pixel or for each point-element of the model. In this sense, image segmentation may relate to the segmentation of the image pixels or to the segmentation of the three-dimensional model that represents the multiple images, which may also be referred to as object separation.

FIG. 4 illustrates a binary mask 400 that represents the segmentation of the object 101 from the background 102. Binary mask 400 has a first value (black) for pixels that are determined to belong to the object 101 and a second value (white) for pixels that are determined to belong to the background 102. The binary mask 400 can now be projected and applied to the images, such as by multiplication, to remove or edit the object or the background separately. While the binary mask 400 of FIG. 4 still shows some gaps and inaccuracies, it is noted that in many examples, the resulting binary mask accurately defines the object in the three-dimensional model. In one example, the modelling and the optimisation of the model parameters comprises a technique referred to as Gaussian splatting.

The optimisation process mentioned above, to adjust the parameters of the point model, involves the multiple images captured by the camera and for each image, the parameter are adjusted. This means that more images should lead to a more accurate point model. However, as described above, the object moves between capturing the images. Therefore, the point model would be adjusted to best fit the different images at different object orientations. This would result in an inaccurate model that models the average of the multiple training images but not each training image individually. In other words, the error with respect to each training image would be relatively high while the overall error across all training images on average is minimised. In yet a different way, the static model would be optimised to fit to multiple dynamic images.

To account for the object movement, spatial transformations are introduced into the model. There are different spatial transformations for the object (F) and the background (B). This is useful because they move relative to each other. Now, these spatial transformations can be applied selectively applying a spatial transformation to each of the point elements depending on the indicator parameter. So for point elements where the indicator parameter indicates that this point element belongs to the object, the object transformation F is applied. For point elements where the indicator parameter indicates that this point element belongs to the background, the background transformation B is applied. This can be gradual depending on the numerical value of the indicator parameter as described in more detail below and may involve calculating a weighted sum of transformed point elements. Once the transformations are applied to all point elements, they can be projected onto a camera imaging plane based on a camera transformation that represents the camera settings used for capturing the ground truth images of the scene. It is noted that the object or foreground transformation F, background transformation B and camera transformation may be different for each of the multiple images. To account for this, an index tis introduced to index a point in time (or a sequential index) when the image is captured.

In one example, method 200 uses surfel-based 2D Gaussian Splatting (2DGS) due to its superior geometry performance and efficiency. 2DGS proposes to collapse the 3D volume into a set of 2D oriented planar Gaussian disks and introduces a perspective-accurate 2D splatting process. Similar to 3DGS, the 2D splat is characterized by its central point pₖ, two principal tangential vectors tᵤ and tᵥ, and a corresponding scaling vector S=(sᵤ, sᵥ) that controls the variances of the 2D Gaussian distribution. These are referred to parameters of the point elements herein. Comparing to 3DGS, 2DGS represents the geometry of the scene better because the oriented planar Gaussian can be perfectly aligned to the surface and the normal direction is well-define as the normal of the plane.

To be specific, a 2D Gaussian disk is defined in a local tangent space in world space, parameterized as:

$$P ( u , v ) = x + {s}_{u} {r}_{u} u + {s}_{v} {r}_{v} v \qquad ( 1 )$$

And for the point u(u, v) in the uv space, its 2D Gaussian value can then be calculated by standard Gaussian

$$G ( u ) = exp ( - \frac{{u}^{2} + {v}^{2}}{2} ) \qquad ( 2 )$$

The center X, scaling (sᵤ, sᵥ), and the rotation (rᵤ, rᵥ) are learnable parameters. Following 3DGS, each 2D Gaussian primitive has opacity α and view-dependent appearance c parameterized with spherical harmonics.

Spherical harmonics Yᵢₘ(θ, φ) are functions defined on the surface of a sphere. To rotate spherical harmonics, we use the Wigner D-matrix [6]. The Wigner D-matrix represents rotation operators for angular momentum states and facilitates rotations in the spherical harmonics space. Algorithm 1 outlines the process for rotating spherical harmonics given a rotation transformation R:

Algorithm 1: Rotate Spherical Harmonics with Wigner D-matrix
Input: Spherical harmonics Yₗₘ, Rotation matrix R Euler angles (α, β, γ)
Output: Rotated spherical harmonics \tilde{Y}ₗₘ
begin
| (α, β, γ) ← RotationMatrix2 [symbol] EulerAngles(R)
| foreach l in degrees of spherical harmonies do
| | D^{l} ← ComputeWignerDMatrix (l, α, β, γ)
| | for m = −l to l do
| | | $\text{?} ← {\sum }_{{m}^{′} = - l}^{l} {D}_{{mm}^{′}}^{l} {Y}_{{lm}^{′}}$
| | end
| end
| return \tilde{Y}ₗₘ
end

[symbol]

indicates data missing or illegible when filed

Instead of projecting the 2D Gaussian primitives onto the image space for rendering, 2DGS derives the intersection point of ray and splat in the local tangent space by plane intersection, which alleviates the problem of splat degeneration, especially at grazing angle. In the rasterization process 2D Gaussians are sorted based on the depth of their centre and volumetric alpha blending is used to integrate alpha-weighted appearance from front to back:

$$c ( x ) = {\sum }_{i = 1} {c}_{i} {α}_{i} {\hat{G}}_{i} ( u ( x ) ) {\prod }_{j = 1}^{i - 1} ( 1 - {α}_{j} {\hat{G}}_{j} ( u ( x ) ) ) \qquad ( 3 )$$

The training process of the 2D Gaussian Splatting method is designed to optimize the geometry and appearance of the 2D Gaussian primitives. The process begins with an initial sparse point cloud and a set of posed images. The model is optimized using a combination of photometric losses and two regularization terms: depth distortion and normal consistency. Photometric losses are used to ensure that the rendered images match the input images as closely as possible. These losses are computed by comparing the rendered images with the ground truth images, and the differences are minimized during the optimization process. This optimization process involves iteratively adjusting the parameters of the 2D Gaussian primitives, including their positions, orientations, scales, opacities, and view-dependent appearances. These parameters are updated using gradient descent, guided by the combined loss functions. The iterative process continues until the accumulated opacity of the rendered images reaches saturation, indicating that the rendered images have sufficiently converged to the ground truth.

Depth distortion regularization addresses the issue of spreading out Gaussians, which can result in similar color and depth rendering. The depth distortion loss concentrates the weight distribution along the rays by minimizing the distance between the ray-splat intersections. This helps in achieving more accurate surface reconstructions by ensuring that the Gaussians are tightly packed along the ray. Normal consistency regularization ensures that the 2D splats are locally aligned with the actual surfaces. The normal consistency loss minimizes discrepancies between the rendered normal map and the gradient of the rendered depth. This alignment ensures that the geometries defined by depth and normals are consistent, leading to smoother and more accurate surface reconstructions.

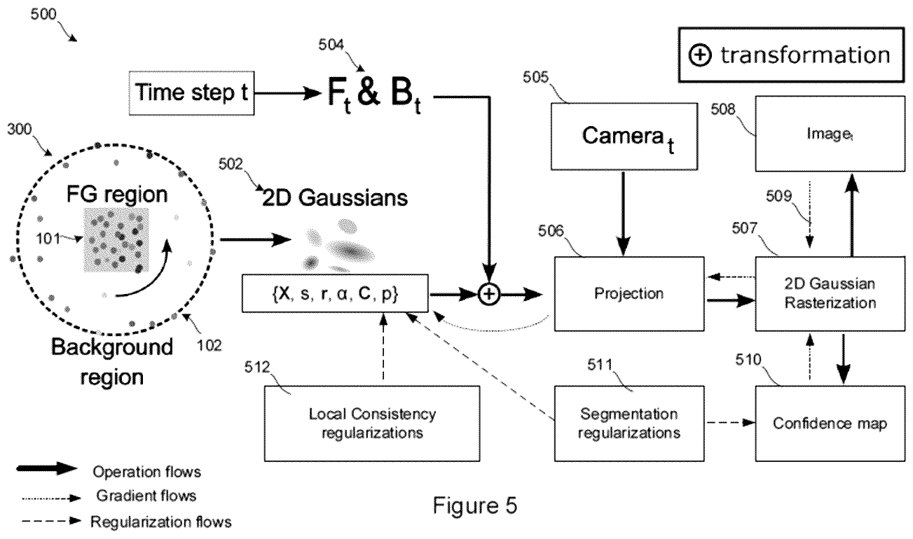

FIG. 5 illustrates a method 500 for 3D object reconstruction and segmentation. Method 500 is a more detailed version of method 200 in FIG. 2. Both methods improve 3D reconstruction of moving rigid objects without the need for input masks since the segmentation is also learned. {x, s, r, α, C, p} are learnable and represent the 3D location of a 2D Gaussian, its 2D scale, 3D rotation, transparency, spherical harmonics, and probability as foreground. F, is the transformation at frame t from the object to the world coordinates. Black arrows are operation flows, dotted arrows gradient flows, and dashed arrows regularization flows.

Method 500 commences with point-based three dimensional model 300 of a scene comprising a foreground region including object 101 and a background 102. As described above, object 101 moves relative to background 102. As also described above, the scene is approximated by point elements, which are 2D Gaussians 502 in this example parameterised by {x, s, r, α, C, p}. Method 500 then applies the transformations 504, including foreground transformation Fₜ and background transformation Bₜ for time step t to the point-elements of the point based model selectively dependent on the value of the indicator parameter p for each point element. Method 500 can also access the camera transformation 505 (position and pose/viewing direction of the camera) and then calculate a projection 506 of the Gaussians onto the camera plane for each index t. Method 500 can then perform a 2D Gaussian rasterization 507 to calculate a rendered image. Method 500 then calculates an error to image t 508, which gives rise to a gradient flow 509 to the rasterization 507, which flows back to the projection 506 and finally to the parameters of the Gaussians that are to be optimised. This also includes the optimisation of the indicator parameter p to create the segmentation between foreground and background. This way, optimising the parameters comprises, for each image, reducing an error between (i) that image 508 and (ii) a rendered representation 507 of the model with the applied spatial transformation 504 specific for that image to account for the pose of the object in that image according to the movement.

Method 500 also maintains a confidence map 510, which provides a further source of a gradient so that the confidence can be maximised. The confidence map 510 is also provided segmentation regularizations 511, which also contributes a regularization flow to the optimisation of the Gaussian parameters 502. Further, there is a local consistency regularisation 512 which also regularises the optimisation as disclosed herein.

### Method

The disclosed approach for 3D reconstruction of moving objects is particularly advantageous in environments with cluttered and static backgrounds. The method eliminates the need for explicit background masks by employing a fully self-supervised Gaussian segmentation technique.

### Problem Formulation

Cluttered and static backgrounds pose significant challenges for 3D reconstruction of objects on rotating tables, for example. Existing methods often struggle to reconstruct objects without explicit background masks. While some methods perform better when provided with masks, they are still affected by the mask quality, which is especially for low for a cluttered background and a complex foreground object. So there is a need for a better approach that does not depend on input masks for background-foreground separation.

One goal is to address the challenge of reconstructing 3D models from multiple views in scenarios involving moving objects. For demonstration, a turntable setup is typical in 3D object scanning setups where the object rotates on a rotating table, and cameras capture images from discrete elevation angles. Often in production environments, unlike a lab environment, the scene includes cluttered, static backgrounds that are difficult to remove, posing challenges for accurately reconstructing the foreground object. Errors in background removal can severely impact the accuracy of 3D reconstruction.

To be specific, the disclosed approach involves partitioning the scene into two distinct regions: the dynamic foreground (also referred to as “object”) and the static background. The foreground region encompasses the target object that rotates with the turntable. It is assumed that the foreground object is rigid, and its movement is consistent across the region. However, it is possible to segment multiple objects in the scene using a more than binary indicator variable. The background region encompasses all other static elements in the scene.

Given a set of images I={Iₜ|t=1, 2, . . . , n} captured at n discrete time steps, there are several transformations associating the camera and the scene. Firstly, a first spatial transformation relates to a pose of the camera, that is, the camera poses

T={Tₜ∈R^{4×4}|t=1, 2, . . . , n} are defined as the transformation from the camera to the world coordinate system by:

$${X}_{t} = {T}_{t} \cdot {x}^{c} \qquad ( 4 )$$

where x^{c} is the homogeneous coordinates in the camera coordinate system and Xₜ is the corresponding coordinate in the world coordinate system at time step t. It is noted that timestep t is used as an index for the images since they are captured over time. In this sense, a specific value of t can indicate a specific image or a specific point in time.

Secondly, a second transformation relates to the pose of the object, that is, the transformations F={Fₜ∈R^{4×4}|t=1, 2, . . . , n} from the dynamic foreground to the world coordinate system are defined by:

$${X}_{t} = {F}_{t} \cdot {x}^{f} \qquad ( 5 )$$

where x^{ƒ} is the homogeneous coordinate in the foreground coordinate system. In this sense, the spatial transformation Fₜ relates to the pose of the object according to the movement. It is noted that the movement may have a number of different components, such as rotation and translation. In some examples provided herein, the movement by the object is a rotation about a single axis (e.g. turntable) but other movements are equally possible. The movement may be given by the mechanical setup, such as given rate of rotation, control of a stepper motor or servo. That is, a controller may control an actuator to impart a desired movement onto the object and the desired movement is also used as Fₜ in the algorithm. In other examples, the movement is measured, such as by sensors, including inertial sensors, rotary encoders or other sensors. Further, the camera itself may also capture the movement such as by identifying a fiduciary marker that can be used to calculate the pose of the object from the image data for each image.

Similarly, the transformations B={Bₜ∈R^{4×4}|t=1, 2, . . . , n} from the static background to the world coordinate system are defined by:

$${X}_{t} = {B}_{t} \cdot {x}^{b} \qquad ( 6 )$$

where x^{b} is the homogeneous coordinate in the background coordinate system.

Note that the local coordinates x^{ƒ} and x^{b} are irrelevant to the time step t because the scene is assumed rigid without any deformation. Since the background is static, Bₜ is actually all the same across different time stamps. Furthermore, by setting {Bₜ=I|t=1, 2, . . . , n} where I∈R^{4×4} is the identity matrix, it is possible to simplify the representation by aligning the world coordinate system rightly with the background coordinate system without loss of generality. Thus, there is the relation

$${X}_{t}^{w} = {x}^{b}$$

for any point in the background region at any time. These poses can be estimated by running a structure-from-motion method on the two separated regions or pre-calibration of the camera set-up and thus are assumed to be known in this paper.

### Extended 2D Gaussian

One aspect of addressing this problem involves accurately separating the static and dynamic regions to process each area appropriately. This disclosure utilises segmentation in a fully self-supervised manner. Firstly, 2D Gaussians are used as scene representation method in one example, noting that other point-based models can be used. This choice is motivated by the method's use of point-based representation, which explicitly defines the scene using thousands of Gaussian primitives. This approach allows to easily assign customized attributes to the Gaussians.

The scene 100 is represented by 2D Gaussian primitives which comprise of a series of learnable parameters {xᵢ, sᵢ, rᵢ, αᵢ, Cᵢ}, where xᵢ∈R³ denotes the position of the Gaussian's centre, sᵢ∈R² is the scale of the 2D Gaussian, rᵢ∈R^{k} is its rotation (orientation) represented by a quaternion, a; ER is the opacity, and Cᵢ∈R^{k} is spherical harmonic coefficients of the Gaussian primitive. Apart from these parameters, method assigns an additional indicator parameter that identifies whether each Gaussian is static or dynamic. This distinction allows to apply appropriate transformations to the static and dynamic Gaussians accordingly. In case that a native binary indicator is not differentiable and is not capable to be optimized by gradient descent. It is possible to use a continuous parameter p∈[0,1] to indicate the probability of a Gaussian primitive belonging to the foreground region. That is, the indicator parameter is continuous between (i) a first value (‘1’) indicating that the point element belongs to the object and (ii) a second value (‘0’) indicating that the point element belongs to a background. Such a continuous indicator parameter enables optimising the parameters performing a gradient descent method. Ideally (see FIG. 4), for any dynamic Gaussian in the foreground should have p=1, while others in the background will have p=0. Thus, the learnable parameters of a 2D Gaussian primitive are extended to be {xᵢ, sᵢ, rᵢ, αᵢ, Cᵢ, pᵢ}. According to this formulation, the scene can comprise multiple moving objects there are one or more indicator parameters for each Gaussian that are indicative of whether that point element belongs to one of the multiple objects in the scene. In that case, there may also be multiple F, transformations for respective objects. However, for ease of illustration, this disclosure provides examples with a single object.

### Self-Supervised Gaussian Segmentation

The proposed method realizes fully self-supervised Gaussian segmentation by integrating the foreground probability p (referred to as “indicator parameter” herein) into the rendering process differentially.

The disclosed method segments the scene into foreground and background regions and each region is related to the world coordinate system by the transformations F and B. Instead of putting everything in the world coordinate system directly like other Gaussian Splatting methods, the proposed method initializes the Gaussians in the local coordinate systems. In the rendering process, the method transforms the Gaussians to the world coordinate system by the transformations F and B.

The transformation is performed probabilistically according to the foreground probability pᵢ. To be specific, given a Gaussian primitive whose centre position is xᵢ in its local coordinate system, it will be transformed to the world coordinate system at time step t by:

$${X}_{i}^{t} = {p}_{i} {F}_{t} \cdot {x}_{i} + ( 1 - {p}_{i} ) {B}_{t} \cdot {x}_{i} \qquad ( 7 )$$

where

$${X}_{i}^{t}$$

is the coordinate of the transformed centre point in the world coordinate system at time step t. Intuitively understanding of the formulation, the method calculates the expectation of the transformed Gaussian's centre according to the foreground probability pᵢ. With the proposed soft version of the aforementioned transformation, the process is fully differentiable, and the probability parameter pᵢ can be optimized with the photometric loss by gradient descent. There may be no explicit supervision for the probability pᵢ.

As the training process is converging, the probability pᵢ is expected to be pushed closely to either 0 or 1 and Equation (7) will degenerate to either (5) or (6) meaning the Gaussian primitive is correctly transformed to the world coordinate system. In this way, the method can segment the Gaussians into foreground and background automatically.

Recall the parameters of the 2D Gaussian {xᵢ, sᵢ, rᵢ, αᵢ, Cᵢ, pᵢ}, apart from the centre position xᵢ which is already transformed, the method also transforms the rotation-related parameters rotation vector rᵢ and spherical coefficients Cᵢ from the local space to the world space. The method may not use the same soft transformation for the rotation vector and spherical coefficients because both rᵢ and Cᵢ are only related to the SO3 rotation transformation. According to, linear interpolation in SO3 space is not straightforward, and it may add complexity to the optimization problem. Therefore, it was chosen to transform the left parameters in a ‘hard’ way. Firstly, the method determines the attribute of the Gaussian by a thresholding strategy. For each Gaussian, the binary indicator Pᵢ is achieved by:

$${P}_{i} = \{ \begin{matrix}True & if {p}_{i} \geq τ \\ False & if {p}_{i} < τ\end{matrix} \qquad ( 8 )$$

where τ is a hyperparameter and empirically set to τ=0.8 for all the experiments.

Then, the method transforms the rotation vector rᵢ and spherical coefficients Cᵢ according to the corresponding transformations F or B.

For a rotation vector rᵢ of a foreground Gaussian, the method applies the rotation component of the transformation F directly by:

$${r}_{i}^{t} = {R}^{- 1} ( {F}_{t}^{3 \times 3} \cdot R ( {r}_{i} ) ) \qquad ( 9 )$$

where R is the mapping from a quaternion to a rotation matrix, and

$${F}_{t}^{3 \times 3}$$

is the rotation component of the transformation Fᵢ and

$${r}_{i}^{t}$$

is the transformed rotation vector at time step t. For the sake of simplicity, the transformation for background Gaussians may be omitted as it may be the same as that for the foreground and it can be assumed to be identical.

The method also transforms the spherical coefficients Cᵢ with the help of Wigner D-matrix.

### Optimization

This section introduces the loss functions disclosed to facilitate training, especially for the self-supervised Gaussian segmentation. Since it is unknown where the background or the foreground is, three regularization loss functions are used.

Local Consistency Loss. As a prior knowledge, Gaussians belonging to the same region tend to gather while those from different regions are usually away from each other. That is to say, the distribution of foreground probability p should be consistent within a local region. Based on the analysis, a Local Consistency Loss is disclosed to regularize the learning of the probability pᵢ. For each Gaussian, the loss encourages other k-nearest Gaussians to have a similar distribution of the foreground probability. As shown in (10), for each Gaussian, the L_{lc} is defined as the KL divergence of the foreground probability.

$${L}_{l c} = \frac{1}{k} {\sum }_{j = 1}^{k} {D}_{K L} ( {p}_{i} ‖ {p}_{j} ) \qquad ( 10 )$$

3D segmentation regularization. The parameter pᵢ is defined as the probability that a Gaussian belongs to the foreground. With the proceeding of the training process, p should be more deterministic that it becomes close to either 0 or 1. The method may use the point-wise loss L_{3ds} to force the probability of each Gaussian to be deterministic.

$${L}_{3 d s} = \frac{1}{k} {\sum }_{i = 1}^{k} - ( {p}_{i} log ( {p}_{i} ) + ( 1 - {p}_{i} ) log ( 1 - {p}_{i} ) ) \qquad ( 11 )$$

2D segmentation regularization. The method also applies similar regularization in the 2D image space. A confidence map C is rendered by replacing the color information c, with the probability pᵢ in (3). Then, a similar regularization L_{2ds} is also applied to the confidence map by:

$${L}_{2 ds} = E [ - ( C log ( C ) + ( 1 - C ) log ( 1 - C ) ) ] \qquad ( 12 )$$

Overall. The method also incorporates losses Lₒᵣᵢ including a normal consistency loss and a photometric loss. Combined them together, the total loss L used for training is

$$L = {L}_{ori} + {λ}_{l c} {L}_{l c} + {λ}_{3 ds} {L}_{3 d s} + {λ}_{2 ds} {L}_{2 d s} \qquad ( 13 )$$

### Specular Surfaces

In some examples, the scene comprises specular or reflective surfaces. These can be difficult to reconstruct because the reflection actually represents another part of the scene. As a result, some 3D reconstruction may provide inaccurate or noisy results. This disclosure proposes a foundation network to use single image, estimate depth and normal maps. The normal map can then guide reconstruction. In other words, for the reflective surfaces, the method can learn the illumination of the environment. The scene-foundation model learns the depth and normal maps for use for 2DGS. The model also learns an environment map to make sense of reflection. This means the model can render the environment map on the reflective surface of the object and compare the result to the input image to thereby reduce the error between the input image and the rendering. The foundation model may be trained separately.

The model employs a encoder-decoder architecture. At its core, the model utilizes a vision transformer (ViT) backbone as its encoder, which has been specifically modified for the depth estimation task. The encoder processes input images by first partitioning them into non-overlapping patches, typically 16×16 pixels, and then processes these patches through multiple transformer layers. Each transformer layer implements self-attention mechanisms that allow the model to capture both local and global dependencies across the image simultaneously.

The model incorporates a positional encoding scheme—it uses a hybrid approach that combines learned absolute positional embeddings with relative positional bias. This enables the model to better understand spatial relationships while maintaining translation equivariance where beneficial. The attention mechanism is enhanced with a sparse attention pattern that reduces computational complexity while maintaining performance. In the decoder pathway, the model employs a hierarchical structure that progressively upsamples and refines the depth predictions. The decoder uses cross-attention modules to effectively combine features from different scales of the encoder, similar to skip connections in U-Net architectures, but with the added benefit of attention-based feature selection. This allows the model to preserve fine details while maintaining global context.

The loss function formulation may combine multiple components: a scale-invariant gradient matching term that ensures consistent depth relationships, a normal vector consistency term that enforces surface smoothness, and an edge-aware term that helps preserve sharp depth discontinuities at object boundaries. The loss function also incorporates a metric depth supervision component when such ground truth is available during training.

The model implements an inference pipeline through optimization of the attention mechanisms and strategic use of memory access patterns. It employs a custom CUDA implementation for its core operations, particularly in the attention computation and feature upsampling stages. This allows it to achieve inference times under one second on modern GPU hardware while maintaining high accuracy.

During training, the model uses a mixed training strategy that combines synthetic data (where perfect ground truth is available) with real-world data (where ground truth might be noisy or incomplete). The training process employs a curriculum learning approach, gradually increasing the complexity of scenes and the weight of different loss components.

For handling scale ambiguity, which is inherent in monocular depth estimation, the model may introduce a scale calibration module that learns to predict absolute scale factors by leveraging semantic cues and statistical priors learned from the training data. This allows the model to output metric depth values rather than just relative depths.

The architecture also includes several practical considerations for robust real-world performance, such as handling varying input resolutions through adaptive pooling layers, and implementing test-time augmentation strategies that can be selectively enabled for applications requiring higher accuracy at the cost of increased computation time.

Geometric Properties from Gaussian

To reconstruct the surface of the object and utilize the geometric information from the foundation models, the depth and normal rendering can be derived from the 2D Gaussian primitives.

Normal: Different from other 3DGS-based methods that assume the direction of the axis with a minimum scale factor as the normal direction, the 2D Gaussian primitives in 2DGS have a well-defined normal direction as the normal of the plane. The normal of each 2D Gaussian primitive can be calculated by the cross product of the two principal tangential vectors:

$$n = {t}_{u} \times {t}_{v} \qquad ( 4 )$$

and the normal vector of a point x in the screen space can be rendered similar to the color in eq:color_integration as:

$$\hat{N} ( x ) = {\sum }_{i ∈ M} {n}_{i} {α}_{i} {\prod }_{j = 1}^{i - 1} ( 1 - {α}_{j} ) \qquad ( 5 )$$

The low-pass filter G can be omitted in the following equations for simplicity.

It is noted, that in some examples, the disclosed method based on foundation models to predict the normal direction works well for reflictive, mirroring (specular) surfaces. For lambertian surfaces, the disclosed 3DGS method yields accurate results. For other examples, such as surfaces that are between mirroring and lambertian, it is also possible to use depth and normal data from an image sensor that also captures depth data (e.g., RGBD camera). It is then possible to extract the normal map from the depth data from the camera to provide the geometry supervision in 2DGS optimisation.

Depth: For the depth, the method follows 2DGS to render the expected depth from the depth by intersections of Gaussians and ray by:

$$D ( x ) = {\sum }_{i ∈ M} {d}_{i} {α}_{i} {\prod }_{j = 1}^{i - 1} ( 1 - {α}_{j} ) / {\sum }_{i ∈ M} {α}_{i} {\prod }_{j = 1}^{i - 1} ( 1 - {α}_{j} ) \qquad ( 6 )$$

Supervision from Foundation Models

The monocular depth and normal estimation models infer the geometric information from a single image based on the knowledge of massive training data. Thus, they are insusceptible to the reflective surface problem. Such models can be used to predict normal Ñ and depth \tilde{D} for each image. The foundation models can produce faithful prediction for the object with different materials. The disclosed method uses the predicted normal Ñᵢ and depth \tilde{D}ᵢ as pseudo ground-truth for additional supervision. To be specific, the disclosed method supervises the rendered normal map with L₁ and cosine loss by:

$${L}_{n} = {‖ {\hat{N}}_{i} - {\tilde{N}}_{i} ‖}_{1} + ( 1 - {\hat{N}}^{T} \tilde{N} ) \qquad ( 7 )$$

As for the depth supervision, the method uses scale-invariant depth loss to supervise the rendered depth map by:

$${L}_{d} = {‖ ( ω \hat{D} + b ) - \tilde{D} ‖}^{2} \qquad ( 8 )$$

where ω and b are the scale and shift used to align the rendered depth \hat{D} and the predicted depth \tilde{D}. This is solved for the ω and b by a least-square optimization.

### Shading the Gaussians

In Gaussian Splatting, the color of each Gaussian primitive is represented by a view-dependent appearance c parameterized with spherical harmonics. However, the appearance of the reflective surface is not well described by the spherical harmonics. This disclosure introduces a physical-based rendering (PBR) pipeline by leveraging the rendering equation to formulate the radiance at a viewing direction ωₒ of a point x as:

$${L}_{o} ( x , {ω}_{0} , n ) = {\int }_{Ω} {f}_{r} ( x , {ω}_{i} , {ω}_{0} ) {L}_{i} ( x , {ω}_{i} ) ( n \cdot {ω}_{i} ) d {ω}_{i} \qquad ( 9 )$$

where Ω denotes the upper hemisphere centered at x, n is the normal of the local surface, Lᵢ is the incoming radiance from the direction ωᵢ and ƒᵣ is the bidirectional reflectance distribution function (BRDF).

The BRDF ƒᵣ can be divided into diffuse and specular components and further decompose according to the Cook-Torrance BRDF model as follows:

$${f}_{r} ( {ω}_{i} , {ω}_{0} ) = {\underbrace{( 1 - m ) \frac{a}{π}}}_{diffuse} + {\underbrace{\frac{D F G}{4 ( {ω}_{i} \cdot n ) ( {ω}_{0} \cdot n )}}}_{specular} \qquad ( 10 )$$

where a, m, ρ are the albedo, metallic, and roughness of the surface respectively, D is the normal distribution function, F is the Fresnel term, and G is the geometry term. The computations of D, F and G are related to the surface properties.

According to eq:brdf, the rendering equation can be rewritten as the sum of the diffuse L_{d} and specular Lₛ terms:

$${L}_{o} ( x , {ω}_{0} , n ) = {L}_{d} + {L}_{s} , where \qquad ( 11 )$$

$${L}_{d} = ( 1 - m ) \frac{a}{π} {\int }_{Ω} {L}_{i} ( x , {ω}_{i} ) ( {ω}_{i} \cdot n ) d {ω}_{i}$$

$${L}_{s} = {\int }_{Ω} \frac{D F G}{4 ( {ω}_{i} \cdot n ) ( {ω}_{0} \cdot n )} {L}_{i} ( x , {ω}_{i} ) ( {ω}_{i} \cdot n ) d {ω}_{i} .$$

A trainable High Dynamic Range (HDR) cube map may be used to represent the environment lighting Lᵢ(ωᵢ). The diffuse term L_{d} can be pre-computed and stored as a 2D texture map. As for the specular term Lₛ, the method may employ a split-sum approximation to simplify the specular term of the integration.

The disclosed method achieves significantly better results compared to other Gaussian-based approaches and is comparable to SDF-based methods. It also holds some advantages in finer details than the SDF-based method, as highlighted in the figure.

Forward Shading Vs. Deferred Shading

In order to combine 2D Gaussian primitives with the physical-based rendering (PBR) pipeline, the disclosed method assigns each Gaussian primitive an additional set of PBR parameters (a, m, ρ). An approach to render the 2D Gaussian primitives by forward shading, in which the method calculates the radiance of each Gaussian Lₒ(x, ωₒ, n), and finally obtains the accumulated color by alpha-blending. In the forward shading, as illustrated in FIG. 9, all of the Gaussians along the camera ray will contribute to the accumulated color. This may cause inaccuracy because each Gaussian can have a different normal direction, position, and it is not essential that they are all aligned with the normal of the surface. (2) The forward shading is computationally expensive because the shading calculation is performed for each Gaussian primitive.

Based on the above analysis, it is possible to adopt the deferred shading technique to render the Gaussians. Deferred shading is a rendering technique that decouples the shading and lighting calculations from the geometry rendering. It improves the rendering quality in the presence of specular reflections. The rendering process is divided into two stages: the geometry rendering and the shading stage. In the geometry rendering stage, the method renders the depth, normal and PBR parameters of the scene into the G-buffer. In the shading stage, the method only shades the ray once based on the G-buffer information. As illustrated in FIG. 9, the deferred shading allows to shade the ray at the correct shading point and normal direction, producing more accurate shading results.

TABLE 1
The Chamfer-L₁ ↓ distance of 3D reconstruction results on the Blender Glossy dataset.
The disclosed method achieves top results among GS-based approaches at similar computational
cost, and second best for SDF-based approaches at an order of magniture less computational cost.

| | SDF-based | | Gaussian-based | | | |
|---|---|---|---|---|---|---|
| | TensoSDF | NERO | GShader | GS-IR | R3DG | Ours |
| Angel | second0.0038 | best0.0034 | third0.0060 | 0.0110 | 0.0090 | 0.0061 |
| Bell | third0.0066 | best0.0032 | 0.0078 | 0.1097 | 0.0403 | second0.0037 |
| Cat | third0.0267 | best0.0044 | 0.0175 | 0.0566 | 0.0326 | second0.0074 |
| Horse | best0.0033 | second0.0049 | 0.0072 | 0.0149 | 0.0117 | third0.0050 |
| Luyu | third0.0083 | best0.0054 | 0.0101 | 0.0224 | 0.0151 | second0.0076 |
| Potion | second0.0064 | best0.0053 | 0.0382 | 0.0593 | 0.0380 | third0.0088 |
| Tbell | third0.0212 | best0.0035 | 0.0308 | 0.0989 | 0.0472 | second0.0078 |
| Teapot | third0.0085 | best0.0037 | 0.0178 | 0.0693 | 0.0488 | second0.0083 |
| Average | third0.0106 | best0.0042 | 0.0169 | 0.0553 | 0.0303 | second0.0068 |
| Training | 6 | 12 | 0.5 | 0.5 | 1 | 0.7 |
| Time (h) | | | | | | |

### Training Objective

The model can be trained with multiple loss functions, including the basic losses L_{GS} from 2DGS including RGB reconstruction loss and normal consistency loss, the geometric losses Lₙ and L_{d} from the foundation models as proposed herein.

There may also be regularization terms on the lighting and PBR parameters to facilitate the training process, including natural light regularization by:

$${L}_{light} = {‖ L - \overline{L} ‖}^{2} \qquad ( 12 )$$

where L is the predicted environment lighting and L̅ is the mean of three channels. We also introduce the regularization on the PBR parameters from [70] assuming those properties will not change dramatically in the region of smooth color:

$${L}_{p b r} = ‖ ∇ X ‖ exp ( - ‖ ∇ {C}_{g t} ‖ ) \qquad ( 13 )$$

where X is the rendered map of PBR parameters similar to eq:color_integration and C_{gt} is the ground-truth color.

In total, the final loss function is formulated as a combination of all the losses:

$$L = {L}_{G S} + {λ}_{n} {L}_{n} + {λ}_{d} {L}_{d} + {λ}_{light} {L}_{light} + {λ}_{pbr} {L}_{pbr} \qquad ( 14 )$$

GS-2DGS may be implemented mainly based on the original 2DGS. The 2DGS uses {x, s, t} and {α, c} to represent its geometric and volumetric appearance properties respectively, where x is the position of the Gaussian, s and t are the scale and rotation of the axis, α is the opacity and c is the SH coefficients. Apart from those properties, the method may add PBR parameters {a, m, and r} to represent the albedo, metalness, and roughness of the Gaussian.

### Usage of Foundation Models

Normal Estimation: The method may use a pre-trained model fine-tuned for normal estimation for its robust performance on the reflective objects.

Depth Estimation: For depth estimation, the method may use the masked RGB images without the background for better performance.

### Implementation Details

Initialization. To minimize manual labor, it may be desirable not to use SfM points to initialize the point cloud. Instead, a random initialization approach can be adopted. As described earlier, the Gaussians are defined in the local coordinate systems. For the foreground region, the method randomly initializes Gaussians within a cube region centered at the origin. As for the background region, the method initializes Gaussians roughly on a sphere with 4 times the radius than the side length of the cube with uniform distribution—. The foreground probability is initialized to be pᵢ=0.9 for Gaussians in the foreground region and pᵢ=0.1 in the background region. The method randomly initializes other parameters.

Optimization The method may be implemented by PyTorch and CUDA and optimized by the Adam optimizer. All the experiments are conducted on a single NVIDIA RTX4090 GPU. Training uses 30000 iterations in total. For the training loss, λ_{lc}=50, λ_{3ds}=0.1 and λ_{2ds}=0.1 are used for the real dataset and λ_{lc}=50, λ_{3ds}=0.01 and λ_{2ds}=0.01 for the synthetic dataset, respectively. The regularization losses L_{lc}, L_{3ds} and L_{2ds} are enabled after 5000 iterations.

### EXPERIMENTS

### Experimental Settings

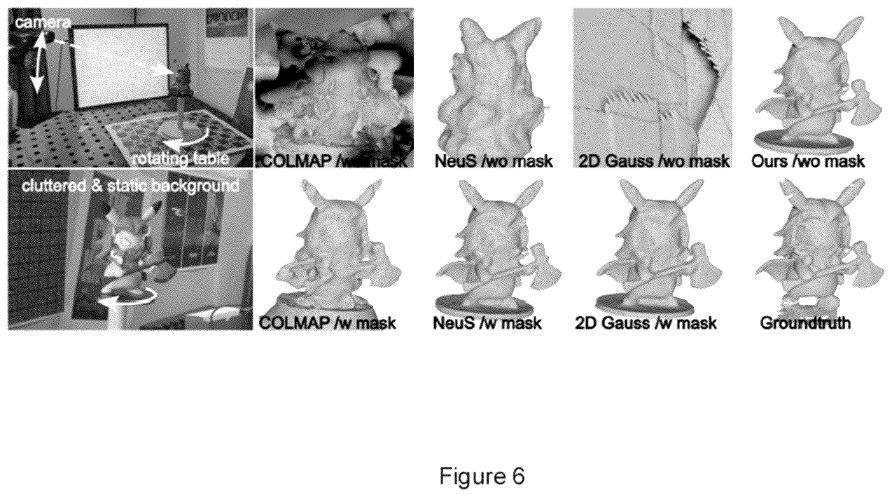

Datasets We captured a real dataset consisting of 9 objects using a motorized rotating table and a Zivid-Two camera mounted on a UR5e robot arm as shown in the top left inset of FIG. 6. The camera captured RGB-D data at different rotation steps and tilting angles. The depths are converted to point clouds and fused to create a ground truth mesh for comparison. The color images from RGB-D data are used for image-based 3D reconstruction. Masks of moving objects are generated with segment and tracking anything

We also create another synthetic dataset consisting of 9 objects in 3 carefully designed scenarios. The synthetic dataset is used for evaluation only. The advantage of the synthetic dataset is that the ground truth is known accurately because the ground truth is represented by the 3D model used to generate the synthetic data. In other words, there is a virtual 3D model of the scene, the synthetic image data is generated using rendering techniques, and this image data is then used to reconstruct the 3D scene which can then be compared to the original 3D model. The dataset is rendered with Blender Cycles engine with resolution of 800×800. The camera is set at 5 different elevation angles and the foreground object will rotate around for each camera position.

Baselines: in our experimental evaluation, we use four baseline methods to compare performance in 3D scene reconstruction. COLMAP is a Structure from Motion method that reconstructs 3D structures from 2D images using feature matching and optimization. NeuS combines and integrates SDF into the NeRF framework for high-quality surface reconstruction and realistic novel view synthesis. 2DGS uses 2D Gaussian primitives to model and reconstruct geometrically accurate radiance fields, enhancing surface alignment and real-time rendering. Lastly, Deformable 3DGS (D-3DGS) extends 3D Gaussian Splatting to dynamic scenes by modelling changes in geometry and appearance over time, making it ideal for applications involving motion and varying conditions. These baselines provide a comprehensive comparison for our proposed method.

TABLE 1
All experiment results on the real dataset. We report the Chamfer-L₁ ↓ and color each
cell as best, second, and third. The results are scaled up by 100x for better comparison.

| | | | | Con- | | | | | | | |
|---|---|---|---|---|---|---|---|---|---|---|---|
| | Methods | Bear | Captain | troller | Dmask | Dog | Dragon | Pikachu | Plant | Rooster | Avg. |
| mask | COLMAP | 0.0663 | 0.2442 | 0.2246 | 0.2089 | 0.1656 | 4.2967 | 0.4280 | 16.7652 | 0.9057 | 2.5895 |
| | NeuS | 0.0695 | 0.1082 | 0.1484 | 0.1804 | 0.0964 | 0.1247 | 0.2990 | 0.1707 | 0.1839 | 0.1535 |
| | 2DGS | 0.0690 | 0.1153 | 0.1815 | 0.1366 | 0.1063 | 0.1054 | 0.2514 | 0.1458 | 0.1170 | 0.1365 |
| w/o | COLMAP | 34.6392 | 45.4321 | 44.8083 | 35.4063 | 35.6062 | 32.4344 | 35.1575 | 41.1090 | 33.0436 | 37.5152 |
| mask | NeuS | 1.5605 | — | 1.4726 | 2.4949 | — | 2.4661 | 2.5834 | 2.2161 | — | 2.1323 |
| | 2DGS | 26.4271 | 12.4420 | 23.9106 | 18.7352 | — | 20.5928 | 26.6814 | 24.6871 | 26.1505 | 22.4533 |
| | D-3DGS | 2.1397 | 1.6192 | 1.9330 | 1.5135 | 0.5591 | 6.3222 | 0.7764 | 6.1672 | 1.8238 | 2.5393 |
| | S2GS | 0.0769 | 0.1210 | 0.1166 | 0.1075 | 0.0860 | 0.1044 | 0.2966 | 0.1249 | 0.1111 | 0.1272 |
| | (ours) | | | | | | | | | | |

— indicates the method failed to reconstruction a mesh.

### 5.2 Experimental Results

3D surface reconstruction. Table 1 presents the Chamfer-L, distance results for our approach and baselines on the real dataset. Our proposed method outperforms other baselines, achieving the best average Chamfer distance in both masked and unmasked scenarios. It consistently ranks first in several categories, such as Captain, Controller, Dmask, Dog, Plant, and Rooster, indicating its robustness and accuracy in diverse conditions. NeuS also shows strong performance, often securing second or third place, with particularly good results in the masked scenario. 2DGS, while slightly behind NeuS on average, excels in certain categories like Pikachu. COLMAP, despite achieving the best result in the Bear category, generally performs poorly without masks, highlighting its limitations in more challenging scenarios. D-3DGS shows promise in dynamic scenes but has higher average Chamfer distances compared to our method and NeuS.

TABLE 2
All experiment results on the synthetic dataset. We report the Chamfer-L₁ ↓ and color each cell as best,
second, and third. The results are scaled up by 100x for better comparison. Masks are perfectly obtained.

| | Methods | Crab | Insect | Leaves | Marci | Cockchafer | Miyuki | Pigeon | Plant1 | Plant2 | Avg. |
|---|---|---|---|---|---|---|---|---|---|---|---|
| mask | COLMAP | 0.4393 | 0.3603 | 6.2447 | 1.1956 | 0.3907 | 0.8543 | 0.3992 | 2.1638 | 1.8153 | 1.5404 |
| | NeuS | 0.7346 | 0.2815 | 0.6058 | 0.6718 | 0.2689 | 0.7218 | 0.9289 | 2.4874 | 0.6879 | 0.8210 |
| | 2DGS | 0.4403 | 0.3532 | 0.5092 | 0.6210 | 0.3326 | 0.5516 | 0.5990 | 0.9335 | 0.5166 | 0.5397 |
| w/o | NeuS | 13.4557 | 2.7616 | 9.3365 | 30.1131 | 33.9812 | 29.8241 | 9.6987 | 13.4225 | 24.3946 | 18.5542 |
| mask | 2DGS | 39.2561 | 43.8407 | 38.0376 | 89.3802 | 60.4679 | 53.3285 | 44.2398 | — | 31.5418 | 50.0116 |
| | D-3DGS | 13.2224 | 177.8401 | 68.6867 | 24.1406 | 22.0735 | 13.4585 | 63.2310 | 51.7127 | 31.3708 | 51.7485 |
| | S2GS (ours) | 0.4361 | 0.3297 | 0.5154 | 0.6481 | 0.3378 | 0.5592 | 0.5529 | 0.9829 | 0.5378 | 0.5444 |

Table 2 shows the comparisons on the synthetic dataset, from which we can find that our method and 2DGS (benefiting from the perfect masks) show the best overall performance on the synthetic dataset. 2DGS stands out with the best average Chamfer distance in the masked scenarios, demonstrating superior surface reconstruction accuracy. Our method without requiring masks performs consistently well across all objects and achieves the second-best and competitive average Chamfer distance. In categories like Crab, our method secures the best performance without a mask. COLMAP and NeuS show strengths in specific categories but struggle with others, leading to higher average Chamfer distances. D-3DGS, while designed for dynamic scenes, exhibits high variability and generally higher Chamfer distances in this synthetic dataset evaluation.

Overall, we can find that when there exist perfect masks such as in the case of synthetic dataset, 2DGS and NeuS can demonstrate high-quality geometric reconstruction, but show decreased performance in the presence of noisy masks, as observed in the real dataset. Our proposed method consistently delivers the best overall performance without requiring masks, which is important for various practical applications.

TABLE 3
Novel-view synthesis on both real and synthetic datasets. We report the
PSNR ↑, SSIM ↑, and LPIPS ↓ for rendering quality.

| | | Real dataset | | | Synthetic dataset | | |
|---|---|---|---|---|---|---|---|
| | | PSNR | SSIM | LPIPS | LPIPS | PSNR | SSIM |
| | Methods | ↑ | ↑ | ↓ | ↓ | ↑ | ↑ |
| mask | NeuS | 21.35 | 0.854 | 0.149 | 27.02 | 0.937 | 0.050 |
| | 2DGS | 25.10 | 0.915 | 0.065 | 31.45 | 0.959 | 0.050 |
| w/o | NeuS | 18.36 | 0.456 | 0.458 | 19.41 | 0.648 | 0.280 |
| mask | 2DGS | 12.00 | 0.469 | 0.637 | 15.64 | 0.693 | 0.471 |
| | D-3DGS | 23.42 | 0.807 | 0.201 | 19.76 | 0.787 | 0.201 |
| | S2GS (ours) | 31.86 | 0.946 | 0.047 | 33.89 | 0.969 | 0.037 |

Novel-view synthesis. Table 3 presents a detailed comparison for the novel-view synthesis task. Our proposed method achieved the highest PSNR (31.86), SSIM (0.946), and the lowest LPIPS (0.047) without masks in the real dataset, indicating superior image quality and structural similarity. In the synthetic dataset, our method also leads in all metrics with the highest PSNR (33.89), SSIM (0.969), and the lowest LPIPS (0.037). For the scenarios with masks, 2DGS performed second best, but its performance is badly compromised when it switches to scenarios without masks, which is also observed in another baseline-NeuS. Therefore, when applying NeuS and 2DGS for dynamic scenes, masks and their quality are important for their rendered quality, while our approach, requiring no masks, can significantly outperform all baselines in rendering high-fidelity images.

Ablation Study. Table 4 demonstrates the impact of different regularization components on the baseline model's performance in terms of Chamfer-L₁ distance and PSNR metrics, evaluated on the real dataset. The addition of the local consistency regularization term (L_{lc}) to the baseline model shows significant improvements in both metrics. When 3D segmentation regularization (L_{3ds}) is combined with local consistency, the Chamfer distance slightly improves and the PSNR reaches its best. However, the full model with all three regularization terms, which combines all components, achieves the best Chamfer distance but shows a slight decrease in PSNR, suggesting some trade-offs in combining all regularization terms. Overall, the study highlights that the addition of specific regularization terms can significantly enhance the geometric accuracy and reconstruction quality of the 3D model. L_{lc} proves to be highly effective in improving both metrics. The segmentation regularization terms (L_{2ds} and L_{3ds}), which help to separate moving objects from the static background, can benefit geometrical reconstruction with the best geometric accuracy, but at a cost of a slight decrease in PSNR.

TABLE 4
Ablation study of regularization terms on the
real dataset. We report Chamber-L₁ for 3D reconstruction
and PSNR for novel-view synthesis.

| Metrics | baseline | +L_{lc} | +L_{3ds} + L_{lc} | full |
|---|---|---|---|---|
| Chamfer-L₁ ↓ | 0.1328 | 0.1296 | 0.1302 | 0.1272 |
| PSNR ↑ | third32.25 | 32.85 | 32.93 | 31.86 |

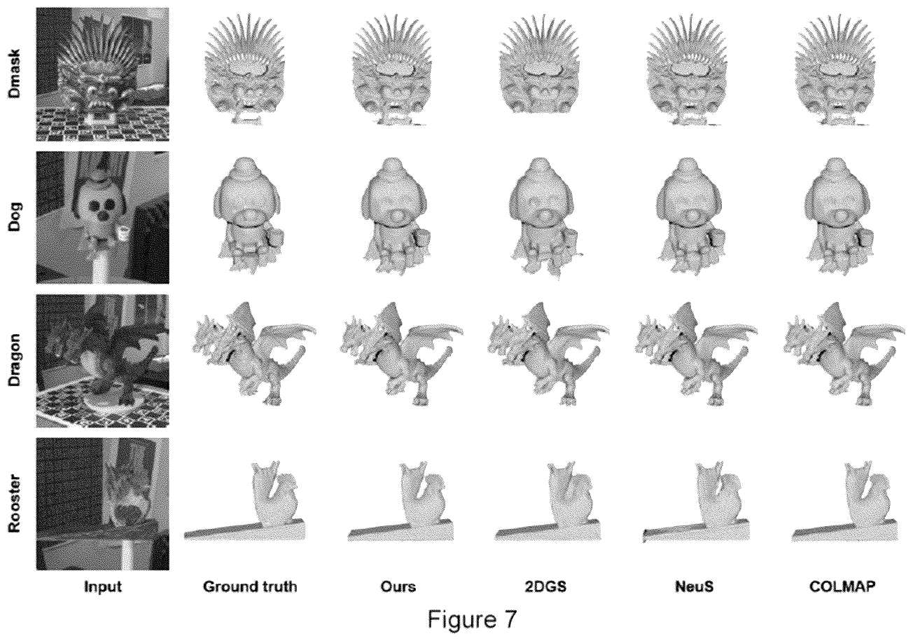

Qualitative comparison. FIG. 7 shows the qualitative comparison results, from which we can observe that our approach demonstrates a smooth surface with accurately detailed reconstruction. When reconstructing sharp and outward spikes in the dmask, baseline methods fail to construct these details accurately. Specifically, 2DGS tends to have enlarged edge effects, and NeuS exhibits eroded effects. In contrast, our approach shows significantly better reconstruction performance in capturing these intricate details. For the case of the Rooster, the impact of the noisy mask on 2DGS and NeuS is evident, particularly in the gap between the head and tail. 2DGS mistakenly reconstructs this gap as part of the foreground objects, leading to inaccuracies. However, our method effectively segments the dynamic and static parts, maintaining a clear distinction and avoiding such errors. This highlights the robustness of our approach to reconstructing moving objects without masks.

### CONCLUSION

This disclosure provides a method for self-supervised segmentation of 2D Gaussians for 3D reconstruction of moving objects, particularly in the case of rotating tables. The approach demonstrates its robustness to cluttered and static backgrounds and reconstructs high-quality 3D models without the need for input masks. On the other hand, other approaches fail without masks. Even with accurate ground truth masks for synthetic data, 2D Gaussian Splatting performs only slightly better than our approach without input masks.

### Computer System

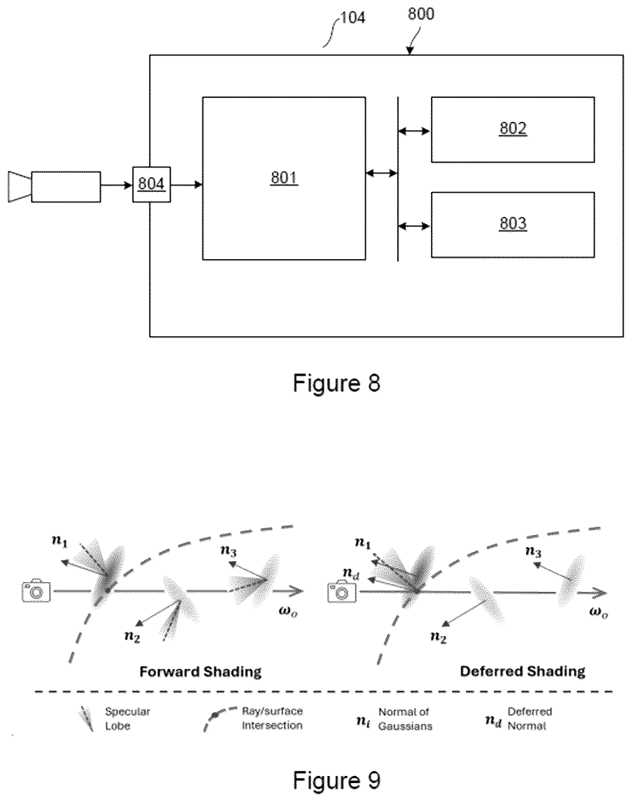

FIG. 8 illustrates a computer system 800 for segmentation of an object in image data. As described above, the image data comprises multiple images of the object in a scene and the object moves relative to the scene over the multiple images. Computer system 800 comprises one or more processors although only one processor 800 is shown. Program memory 802, such as non-transitory computer readable medium, has program code stored thereon that causes processor 801 to perform the methods disclosed herein. In that sense, methods 200 and 500 may be implemented in a programming language, such as C++ or Python, which is then stored (potentially in compiled form) on program memory 802 to thereby configure the processor 801 to perform those methods. Data memory 803 stores data persistently, which may include the image data and the parameter values of the point based model including the indicator parameter for each point element.

As such, processor 801 creates a three-dimensional point-based model of the scene, such as the disclosed 2D Gaussian model. Accordingly, the three-dimensional point-based model comprises multiple parameterised point elements, such as the 2D Gaussian distributions, that are configured to provide an approximation of the scene in three dimensions from the multiple images. Processor 801 then optimises the parameters of the point elements to enhance the approximation of the scene by the model. The parameters of the point elements comprise an indicator parameter for each point element indicative of whether that point element belongs to the object in the scene. Further, processor 801 optimises the parameters of the point elements by optimising the indicator parameter for each point element to segment the object in the scene.

### Raytracing

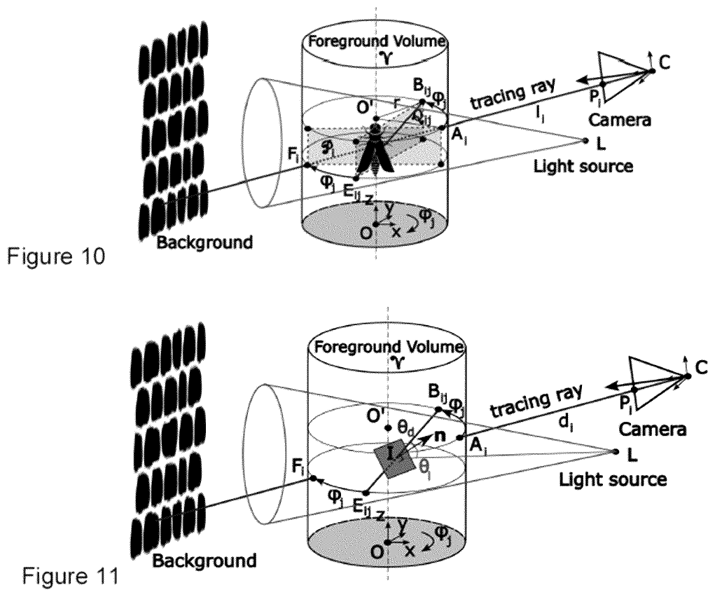

Further disclosed is an approach to deal with static background without the need for image processing to remove cluttered background. FIG. 10 illustrates how this approach works. It assumes the world coordinate system is located at the turntable's rotation centre O, and the rotation axis is aligned to z-axis. A foreground volume V is created as a cylinder to contain the scanned object and aligned to the turntable. The reconstruction method may trace each pixel Pᵢ through the space with a ray lᵢ. The ray hits the rotate volume at point Aᵢ and Fᵢ. before it hits the cluttered background. As the turntable rotate an angle φⱼ, where j the number of rotation steps, the segment AᵢFᵢ also rotates around z-axis an angle φⱼ relative to the foreground volume V.

In FIG. 10 for illustration, Plane Pᵢ parallel to z-axis contains segment AᵢFᵢ and before rotation. After rotation, plane Pᵢ becomes plane Qᵢⱼ which is also parallel to z-axis. This approach provides the following features:
The foreground and background share the same space.
The camera ray is not continuous but broken and rotated by the turntable motion.

This raytracing approach can be applied to a range of reconstruction algorithms including NeRF or NeuS as well as Gaussian splatting.

### Solution for Fixed Directional Light Source

To accommodate the effect of directional light source, the surface normal can also be estimated. The turntable motion is accounted for to reflect the relative movement of the light source around the object, in addition to the relative motion of the camera to the light source. FIG. 11 illustrates a surface normal n at the intersection point I. In addition, the surface roughness can also be modelled.

In other words, if information is available of the space/dimensions that the object occupies, this can be specified in the reconstruction algorithm. Then, the method can reconstruct the object accurately without image segmentation by applying the rotation motion and corresponding ray tracing within that space. In addition, or in cases where the information is not available, the Gaussian splatting method as disclosed herein can be used (e.g. method 200).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for separating an object in image data comprising multiple images of the object in a scene, the object being subject to a movement relative to the scene over the multiple images, the method comprising:
creating a three-dimensional point-based model of the scene, the three-dimensional point-based model comprising multiple parameterised point elements configured to provide an approximation of the scene in three dimensions from the multiple images, the three-dimensional point-based model comprising model parameters including an indicator parameter for each point element indicative of whether that point element belongs to the object in the scene; and
optimising the model parameters of the point elements to enhance the approximation of the scene by the model, including optimising the indicator parameter for each point element to segment the object in the scene.

2. The method of claim 1, wherein the method further comprises, selectively applying a spatial transformation to each of the point elements depending on the indicator parameter, the spatial transformation being specific for each of the multiple images to account for a pose of the object in that image according to the movement.

3. The method of claim 2, wherein selectively applying a spatial transformation comprises multiplying the indicator parameter with the transformation to calculate a weighted sum of transformed point elements.

4. The method of claim 2, wherein the spatial transformation is related to a rotation of the object in the scene.

5. The method of claim 2, wherein optimising the parameters comprises, for each image, reducing an error between (i) that image and (ii) a rendered representation of the model with the applied spatial transformation specific for that image to account for the pose of the object in that image according to the movement.

6. The method of claim 2, wherein the method further comprises determining the spatial transformation based on the image data by one or more of (i) detecting a fiducial marker in the image data and determining a pose of the object based on the fiducial marker or (ii) receiving movement data from a sensor configured to detect the movement of the object.

7. The method of claim 1, wherein the indicator parameter is indicative of whether that point element belongs to the object in the scene or to the background behind the object.

8. The method of claim 1, wherein the indicator parameter is continuous between (i) a first value indicating that the point element belongs to the object and (ii) a second value indicating that the point element belongs to a background.

9. The method of claim 1, wherein the indicator parameter is continuous and optimising the parameters comprises performing a gradient descent method.

10. The method of claim 1, wherein the scene comprises multiple moving objects and one or more indicator parameters for each point element are indicative of whether that point element belongs to one of the multiple objects in the scene.

11. The method of claim 1, wherein each of the point elements comprises a Gaussian radiance field configured by a set of spatial parameters that are optimised to enhance the approximation of the scene by the model.

12. The method of claim 11, wherein the Gaussian radiance field is two-dimensional to approximate surfaces in the scene.

13. The method of claim 1, wherein the method further comprises
defining the point elements in a local coordinate system;
generating a rendered representation of the model by spatially transforming each point element from the local coordinate system to a global coordinate system; and
optimising the parameters by reducing an error between the rendered representation and a corresponding one of the multiple images.

14. The method of claim 13, wherein spatially transforming each point element from the local coordinate system to the global coordinate system is based on the indicator parameter for that point element to apply a spatial transform associated with the object to point elements that belong to the object according to the indicator parameter.

15. The method of claim 1, further comprising transforming spatial parameters of the point elements according to a spatial transformation associated with the object in response to the indicator parameter for that point element satisfying a threshold value.

16. The method of claim 1, wherein the method further comprises creating a three-dimensional representation of the object consisting of the point elements for which the indicator parameter indicates that the point elements belong to the object.

17. The method of claim 1, wherein optimising the parameters is performed under a local consistency constraint that encourages that near point elements have a similar indicator parameter.

18. The method of claim 1, wherein optimising the parameters is performed using a point-wise loss function that encourages the indicator parameter to become deterministic.

19. The method of claim 1, wherein the method further comprises generating an output image in which the indicator parameter is used as a colour value for each point element and the method further comprises applying a two-dimensional segmentation regularization on the output image.

20. A computer system for separating an object in image data comprising multiple images of the object in a scene, the object being subject to a movement relative to the scene over the multiple images, the computer system comprising one or more processors configured to:
create a three-dimensional point-based model of the scene, the three-dimensional point-based model comprising multiple parameterised point elements configured to provide an approximation of the scene in three dimensions from the multiple images, the three-dimensional point-based model comprising model parameters including an indicator parameter for each point element indicative of whether that point element belongs to the object in the scene; and
optimise the model parameters of the point elements to enhance the approximation of the scene by the model, including optimising the indicator parameter for each point element to segment the object in the scene.
